(19) United States
(12) Patent Application Publication
(10) Pub. No.: US 2026/0356445 A1
(43) Pub. Date: Nov. 12, 2026

(54) ADJUSTMENT ASSEMBLY FOR TRACK SYSTEM AND TRACK SYSTEM HAVING SAME

(71) Applicant: SOUCY INTERNATIONAL INC., Drummondville (CA)

(72) Inventors: Gabriel LANDRY, Sainte-Madeleine (CA); Gabriel CHANTAL, Saint-Jude (CA); Yves SAUVAGEAU, Drummondville (CA)

(21) Appl. No.: 19/103,071

(22) PCT Filed: Aug. 24, 2023
(86) PCT No.: PCT/CA2023/051120

§ 371 Date: Feb. 11, 2025

Related U.S. Application Data
(60) Provisional application No. 63/403,340, filed on Sep. 2, 2022.
(60) Provisional application No. 63/404,865, filed on Sep. 8, 2022.
(60) Provisional application No. 63/442,817, filed on Feb. 2, 2023.

(51) Int. Cl. B62D 55/10; B62D 55/14

(52) U.S. Cl. CPC B62D 55/10; B62D 55/14

(57) ABSTRACT

An adjustment assembly includes first and second shafts, and an adjustment element. The first shaft defines a first shaft axis extending along first and second shaft ends of the first shaft. The first shaft end is connectable to a support member. The second shaft defines a second shaft axis extending along third and the fourth shaft ends of the second shaft. The second shaft end is connected to the first shaft such that the first shaft is at least pivotable about the second shaft axis, and is connectable to the support member such that when the first shaft is in a first position relative to the second shaft, the first and second shaft axes are generally perpendicular to one another. The adjustment element, which is engaged with one of the first and second shafts, is suitable for adjusting an orientation of the first shaft axis relative to the support member.

### CROSS-REFERENCE

The present application claims priority to U.S. Provisional Patent Application No. 63/403,340, filed Sep. 2, 2022, which is incorporated by reference herein in its entirety, to U.S. Provisional Patent Application No. 63/404,865, filed Sep. 8, 2022, which is incorporated by reference herein in its entirety, and to U.S. Provisional Patent Application No. 63/442,817, filed Feb. 2, 2023, which is incorporated by reference herein in its entirety.

### TECHNICAL FIELD

The present application generally relates to adjustment assemblies for track systems as well as to track systems having such adjustment assemblies.

### BACKGROUND

Certain vehicles, such as, for example, agricultural vehicles (e.g., harvesters, combines, tractors, etc.), construction vehicles (e.g., trucks, front-end loaders, etc.) and recreational vehicles (e.g., all-terrain vehicles, utility-terrain vehicles, side-by-side vehicles, etc.) are used on ground surfaces that are soft, slippery and/or uneven (e.g., soil, mud, sand, ice, snow, etc.).

Conventionally, such vehicles have had large wheels with tires on them to move the vehicle along the ground surface. Under certain conditions, such tires may have poor traction on some kinds of ground surfaces and, as these vehicles are generally heavy, the tires may compact the ground surface in an undesirable way owing to the weight of the vehicle. For example, when the vehicle is an agricultural vehicle, the tires may compact the soil in such a way as to undesirably inhibit the growth of crops. When the vehicle is a recreational vehicle, the tires may lack traction on certain terrain and in certain conditions.

In order to reduce the aforementioned drawbacks, to increase traction and to distribute the weight of the vehicle over a larger area on the ground surface, track systems were developed to be used in place of at least some of the wheels and tires on the vehicles. For example, under certain conditions, track systems enable agricultural vehicles to be used in wet field conditions as opposed to its wheeled counterpart. In other conditions, track systems enable recreational vehicles to be used in low traction terrains such as snowy roads.

Conventional track systems do, however, present some inconveniences. Endless tracks can become misaligned from their track systems, which can result to premature wear of the endless tracks and/or premature wear of components of the track system. Some conventional track systems provide solutions for correcting the alignment of their endless tracks, such as for example, changing the toe orientation of the track systems in order to correct the alignment.

However, these technologies can be slow to implement and/or can induce high stresses with the track systems. Additionally, incorrectly implementing these technologies can cause damage to the track systems.

Therefore, there is a desire for an adjustment assembly and a track system that could mitigate the above-mentioned issues.

### SUMMARY

It is an object of the present technology to ameliorate at least some of the inconveniences present in the prior art.

According to one aspect of the present technology, there is provided an adjustment assembly for a track system. The adjustment assembly includes a first shaft, a second shaft and an adjustment element. The first shaft, which has a first shaft end and a second shaft end, defines a first shaft axis extending along the first and the second shaft ends. The first shaft end is connectable to a support member of the track system. The second shaft, which has a third shaft end and a fourth shaft end, defines a second shaft axis extending along the third and the fourth shaft ends. The second shaft is connected to the first shaft such that the first shaft is at least pivotable about the second shaft axis, and being connectable to the support member such that in response to the first shaft being in a first position relative to the second shaft, the first and second shaft axes are generally perpendicular to one another. The adjustment element, which is engaged with one of the first and second shafts, is suitable for adjusting an orientation of the first shaft axis relative to the support member.

In some embodiments, the adjustment element is engaged with the first shaft.

In some embodiments, the adjustment element is engaged with the first shaft end.

In some embodiments, the first shaft is connectable to the support member by being at least partially receivable through an aperture defined by the support member, and the adjustment element being at least partially receivable in the aperture.

In some embodiments, the adjustment element is a threaded element.

In some embodiments, movement of the adjustment element is configured to modify orientation of the first shaft axis in a first direction relative to the support member.

In some embodiments, the adjustment assembly further includes a second adjustment element engaged with the one of the first and second shafts.

In some embodiments, movement of the second adjustment element is configured to modify orientation of the first shaft axis in a second direction relative to the support member.

In some embodiments, the first and second directions are opposite to one another.

In some embodiments, the first direction is generally perpendicular to the second direction.

In some embodiments, the adjustment element is disposable between the support member and the one of the first and second shafts.

In some embodiments, each of the third and fourth shaft ends of the second shaft has a flat edge for engagement with the adjustment element, and the adjustment element has a contact surface for engagement with the flat edges of the second shaft.

In some embodiments, the first shaft is configured to rotationally connect to the support member.

In some embodiments, the first shaft is configured to connect to the support member by a spherical joint.

In some embodiments, the first shaft is configured to pivotally connect to the support member.

In some embodiments, the adjustment element is a first adjustment element, the adjustment assembly further includes a second adjustment element, and the first adjustment element is engaged with the third shaft end, and the second adjustment element is engaged with the fourth shaft end.

In some embodiments, the adjustment element is a first adjustment element, the adjustment assembly further includes a second adjustment element, and the first adjustment element is configured to be engaged with the one of the first and second shafts and with the second adjustment element, and the second adjustment element is configured to be engaged with the first adjustment element and the support member.

In some embodiments, the adjustment element is a shim.

In some embodiments, the second shaft extends through the first shaft.

In some embodiments, the adjustment assembly further includes at least one fastener configured to selectively connect the third shaft end to the support member.

In some embodiments, the adjustment assembly, further includes the support member.

In some embodiments, the support member is part of a frame of the track system.

In some embodiments, the support member is part of a vehicle.

According to another aspect of the present technology, there is provided a track system connectable to a vehicle, the track system including a frame assembly, the adjustment assembly according to the above aspect or according to the above aspect and one or more of the above embodiments, a plurality of wheel assemblies connected to the frame assembly, and an endless track. The frame assembly includes a first frame portion and a second frame portion, the first frame portion having a support member. The adjustment assembly interconnects the first and second frame portions. The plurality of wheel assemblies is connected to the frame assembly. The endless track surrounds the frame assembly, the adjustment assembly and the plurality of wheel assemblies.

In some embodiments, the first shaft axis is generally parallel to a longitudinal center plane of the track system when the first shaft axis is in a second position relative to the support member.

In some embodiments, the first shaft axis is generally perpendicular to a longitudinal center plane of the track system when the first shaft axis is in a second position relative to the support member.

According to another aspect of the present technology, there is provided a track system connectable to a vehicle. The track system includes a frame assembly, a plurality of wheel assemblies connected to the frame assembly, an endless track and the adjustment assembly according to the above aspect or according to the above aspect and one or more of the above embodiments. The adjustment assembly is for connecting the frame assembly to the vehicle, and is configurable to adjust an orientation of the frame assembly relative to the vehicle.

According to another aspect of the present technology, there is provided an adjustment assembly for a track system. The adjustment assembly includes a first shaft, a second shaft, a first fastener, a second fastener and at least one adjustment element. The first shaft, which has a first shaft end and a second shaft end, defines a first shaft axis extending along the first and second shaft ends. The first shaft end is connectable to a support member. The second shaft, which has a third shaft end and a fourth shaft end, defines a second shaft axis extending along the third and fourth shaft ends. The second shaft is connected to the first shaft such that the second shaft is rotatable about the first shaft axis. The first fastener is configured to selectively connect the third shaft end to the support member. The second fastener is configured to selectively connect the fourth shaft end to the support member. The at least one adjustment element is configured to be selectively disposed between the second shaft and the support member. The at least one adjustment element is configured to adjust an orientation of the first shaft axis relative to the support member.

In some embodiments, the adjustment of the orientation of the first shaft axis adjusts the camber angle of the first shaft axis relative to the support member.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a track system and components in relation thereto, such as “vertical”, “horizontal”, “forwardly”, “rearwardly”, “left”, “right”, “above” and “below”, are as they would be understood by a driver of a vehicle to which the track system is connected, in which the driver is sitting on the vehicle in an upright driving position, with the vehicle steered straight-ahead and being at rest on flat, level ground.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a right side elevation view of a harvester having track systems according to an embodiment of the present technology;

FIG. 2 is a right side elevation view of the track system of FIG. 1;

FIG. 3 is a right side elevation view of part of a frame assembly and an adjustment assembly of the track system of FIG. 2;

FIG. 4 is a perspective view taken from a right, front, bottom side of the part of the frame assembly and the adjustment assembly of FIG. 3;

FIG. 5 is a cross-sectional view of the part of the frame assembly and the adjustment assembly of FIG. 3 taken along lines 5-5 of FIG. 3;

FIG. 6 is a cross-sectional view of the part of the frame assembly and the adjustment assembly of FIG. 3 taken along lines 6-6 of FIG. 3;

FIG. 7A is a schematic front view of the harvester of FIG. 1, with the track systems being in a first position;

FIG. 7B is a schematic front view of the harvester of FIG. 1, with the track systems being in a second position;

FIG. 7C is a schematic front view of the harvester of FIG. 1, with the track systems being in a third position;

FIG. 8 is a perspective view taken from a right, front, bottom side of an adjustment assembly according to a second embodiment of the present technology;

FIG. 9 is a perspective view taken from a rear, top, left side of part of the adjustment assembly of FIG. 8;

FIG. 10A is a schematic front view of part of the harvester of FIG. 1, with the adjustment assembly in a first configuration;

FIG. 10B is a schematic front view of part of the harvester of FIG. 1, with the track system in a first configuration;

FIG. 10C is a schematic front view of part of the harvester of FIG. 1, with the adjustment assembly in a second configuration;

FIG. 10D is a schematic front view of part of the harvester of FIG. 1, with the track system in a second configuration;

FIG. 10E is a schematic front view of part of the harvester of FIG. 1, with the adjustment assembly in a third configuration;

FIG. 10F is a schematic front view of part of the harvester of FIG. 1, with the track system in a third configuration;

FIG. 11 is a perspective view taken from a right, front, bottom side of an adjustment assembly according to a third embodiment of the present technology; and

FIG. 12 is a perspective view taken from a right, top, front side of part of the adjustment assembly of FIG. 11.

Unless indicated otherwise, the accompanying Figures are not to scale.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

The present technology relates to adjustment assemblies that are configurable to adjust alignment of an endless track of a track system. Thus, the adjustment assembly will be described with reference to a track system that is connected to a vehicle.

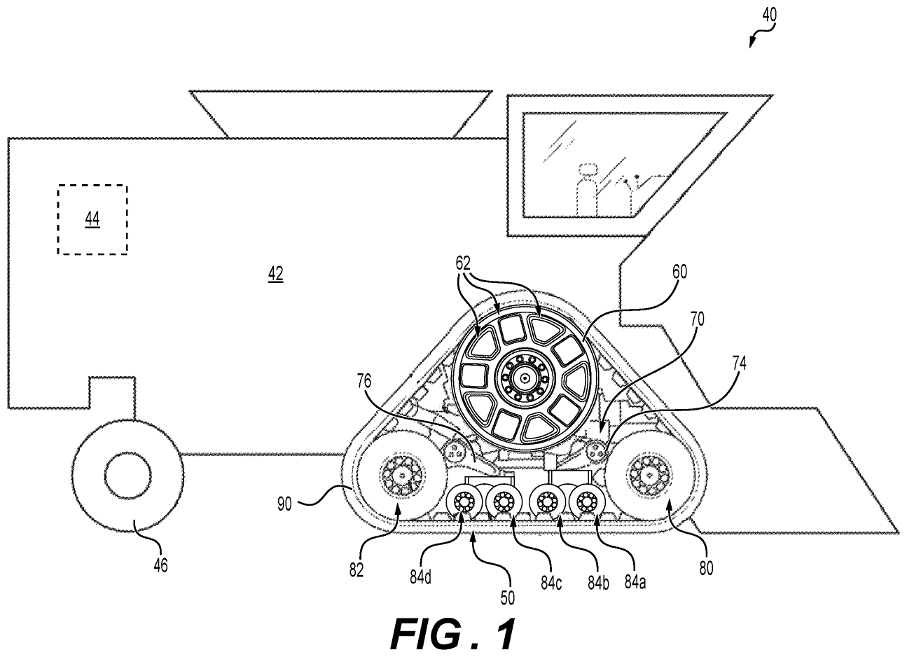

Referring to FIG. 1, a harvester 40 is shown. The harvester 40 has a frame 42 that supports an engine 44 (shown schematically). The harvester 40 also has left and right rear wheels 46 and left and right track systems 50 (only right rear wheel 46 and right track system 50 are shown in the accompanying Figures). It is contemplated that in some embodiments, the harvester 40 could have more than two track systems. The engine 44 is operatively connected to left and right track systems 50. It is contemplated that in some embodiments, the engine 44 could also be operatively connected to the left and right rear wheels 46. Although the present description is made with reference to the harvester 40, it is understood that the present technology could be used with other vehicles such as bulldozers, skid-steer loaders, excavators and/or compact track loaders. In some instances, the present technology could be used with industrial and military vehicles. It is also contemplated that the present technology could be used with trailers or other unpowered vehicles.

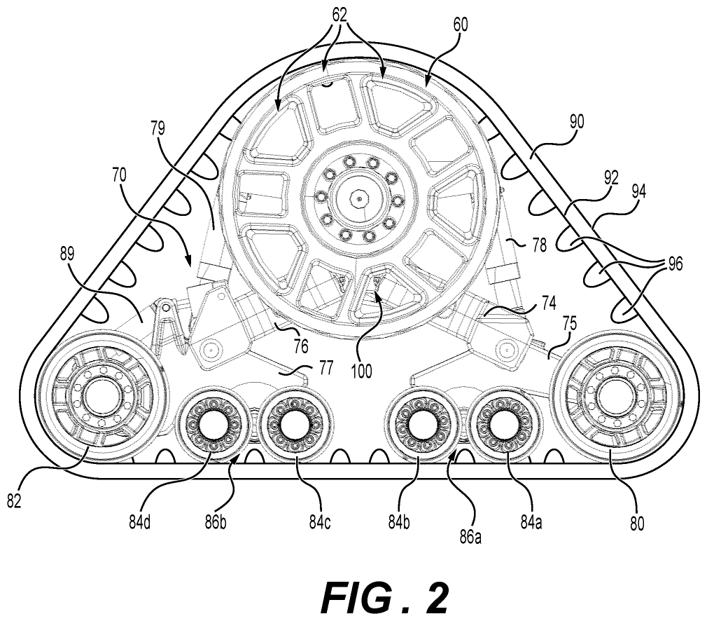

Referring to FIGS. 1 and 2, the track system 50 has a sprocket wheel assembly 60 that is operatively connected to an axle (not shown) of the harvester 40. As a result, when the axle rotates, the sprocket wheel assembly 60 also rotates, which drives the track system 50. The sprocket wheel assembly 60 defines a plurality of recesses 62. The recesses 62 are defined circumferentially on a periphery of the sprocket wheel assembly 60 and are configured to, as will be described in greater detail below, engage with lugs 96 provided on an inner surface 92 of an endless track 90.

Referring to FIGS. 2 to 6, the track system 50 also has a frame assembly 70 that is rotationally connected to the sprocket wheel assembly 60 and that is disposed laterally inwardly therefrom. It is contemplated that in other embodiments, the frame assembly 70 could be disposed laterally outwardly from the sprocket wheel assembly 60. The frame assembly 70 has a central frame member 72, an upper leading frame member 74, a lower leading frame member 75, an upper trailing frame member 76 and a lower trailing frame member 77. The central frame member 72 defines an aperture 73 configured to receive part of the sprocket wheel assembly 60 and/or part of the axle of the harvester 40. The upper leading and trailing frame members 74, 76 are pivotally connected to the central frame member 72 by an adjustment assembly 100, which will be described in greater detail below. Furthermore, the upper leading and trailing frame members 74, 76 are also connected to, respectively, leading and trailing biasing members 78, 79. The leading and trailing biasing members 78, 79 are also pivotally connected to the central frame member 72. The leading and trailing biasing members 78, 79 are commonly referred to as suspension members and are configured to limit and/or dampen pivotal movement of the leading and trailing frame members 74, 76 relative to the central frame member 72. The lower leading frame member 75 is pivotally connected to the upper leading frame member 74, and the lower trailing frame member 77 is pivotally connected to the upper trailing frame member 74. It is contemplated that in other embodiments, the frame assembly 70 of the track system could vary from one embodiment to another. For example, in some embodiments the lower leading and trailing frame members 74, 76 could be omitted. In other embodiments, the frame assembly 70 could have more or less frame members.

The track system 50 includes wheel assemblies. More precisely, in addition to the sprocket wheel assembly 60, the track system 50 includes a leading idler wheel assembly 80, a trailing idler wheel assembly 82 and four support wheel assemblies 84a, 84b, 84c, 84d which are disposed longitudinally between the leading and trailing idler wheel assemblies 80, 82. It is contemplated that in some embodiments, the track system 50 could have more or less than four support wheel assemblies.

The support wheel assemblies 84a, 84b are connected to form a tandem 86a, which in turn is pivotally connected to the lower leading frame member 75, rearwardly from the leading idler wheel assembly 80, which is also connected to the lower leading frame member 75. Similarly, the support wheel assemblies 84c, 84d are connected to form a tandem 86b which in turn is pivotally connected to the lower trailing frame member 77, forward from the trailing idler wheel assembly 82, which is also connected to the lower trailing frame member 77. Thus, the track system 50 can, to some extent, conform to encountered obstacles.

Each one of the leading and trailing idler wheel assemblies 80, 82, and the support wheel assemblies 84a, 84b, 84c, 84d has two laterally spaced wheels, such that each one of the leading and trailing idler wheel assemblies 80, 82 and the support wheel assemblies 84a, 84b, 84c, 84d has left and right wheels (only the right wheel of each one of the wheel assemblies is shown in FIGS. 1 and 2). It is contemplated that in some embodiments, one or more of the leading and trailing idler wheel assemblies 80, 82, and the support wheel assemblies 84a, 84b, 84c, 84d could be configured to have a single wheel or could be configured to have three or more wheels.

The track system 50 further includes a tensioner 89 that is operatively connected to the trailing idler wheel 82 and that is connected to the lower trailing frame member 77. The tensioner 89 is operable to adjust tension in the endless track 90 by causing movement of the trailing idler wheel 82.

The track system 50 defines a longitudinal center plane 52 that is in part defined by the frame assembly 70 and the wheel assemblies.

The track system 50 also includes the endless track 90 that surrounds the frame assembly 70 and the plurality of wheel assemblies 60, 80, 82, 84a, 84b, 84c, 84d.

The endless track 90 has the inner surface 92 and an outer surface 94. The inner surface 92 of endless track 90 has the lugs 96. In the illustrated embodiment, the lugs 96 includes left set and right sets of lugs 96. The left and right sets of lugs 96 are adapted to be received in the recesses 62 of the sprocket wheel assembly 60, as well as to engage with the sprocket wheel assembly 60. It is contemplated that in some embodiments, there could be only one set of longitudinally spaced lugs 96. The outer surface 94 of the endless track 90 has a tread (not shown) defined thereon. It is contemplated that the size and shape of the tread as well as its location on the outer surface 94 of the endless track 90 could vary from one embodiment to another. In some embodiments, the tread could depend on the type of ground surface on which the harvester 40 is destined to travel. In the present embodiment, the endless track 90 is an endless polymeric track. It is contemplated that in some embodiments, the endless track 90 could be constructed of a wide variety of materials and structures.

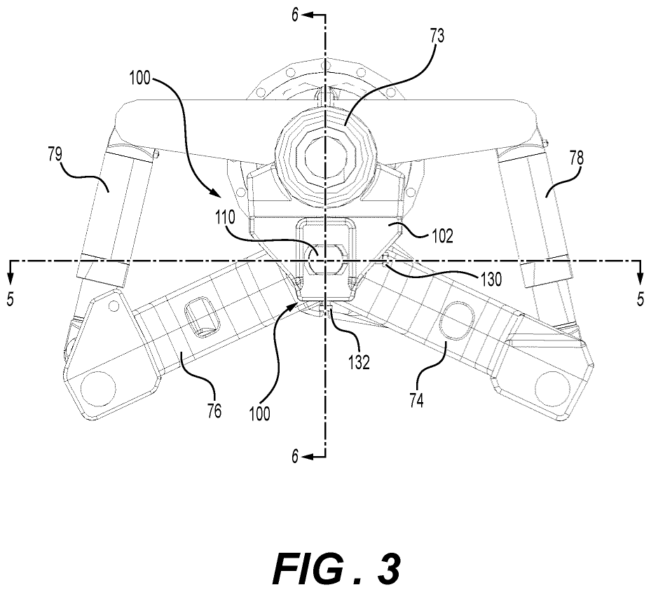

With reference to FIGS. 3 to 6, 7A, 7B and 7C, the adjustment assembly 100 will now be described in greater detail. The adjustment assembly 100 includes a primary shaft 110, a secondary shaft 120, a horizontal adjustment element 130 and a vertical adjustment element 132. As will be described in greater detail below, it is contemplated that in some embodiments, there could be a single adjustment element or more than two adjustment elements.

The adjustment assembly 100 is connected to the central frame member 72 by support members 102, 104. It is contemplated that in other embodiments, the adjustment assembly 100 could be connected to the central frame member 72 by a single support member, or by three or more support members. For example, in some instances, the support members 102, 104 could be connected to one another by a base, thereby forming a single support member. In some implementations of the present technology, the support members 102, 104 could be considered as being part of the adjustment assembly 100. In other embodiments, the support members 102, 104 could be integral with the central frame member 72. Additionally, it is understood that the adjustment assembly 100 could be connected to another member besides the central frame member 72. For instance, in some embodiments, the adjustment assembly 100 could be configured to interconnect the upper and lower leading frame members 74, 75.

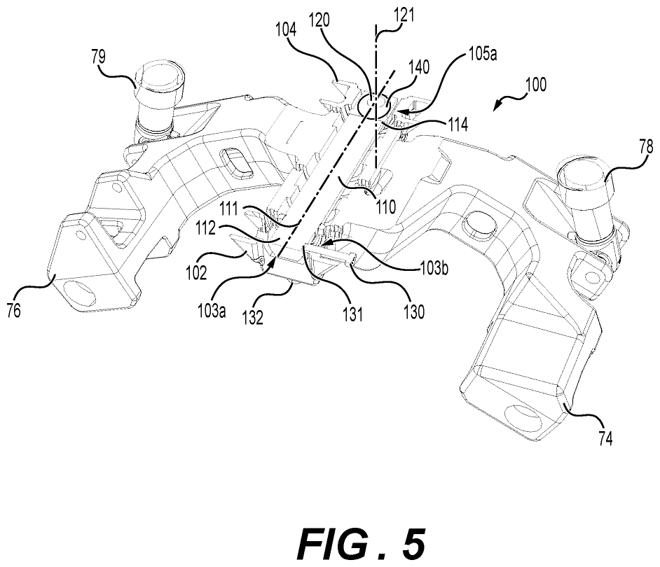

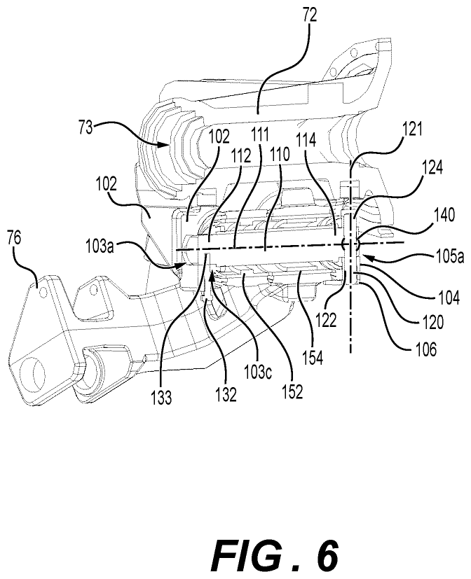

Referring to FIGS. 5 and 6, the support members 102, 104 will now be described in greater detail. The support members 102, 104 are selectively connectable to the central frame member 72 by fasteners (not depicted in accompanying Figures). The support members 102, 104, which extend downwardly from the central frame member 72, are laterally spaced from one another, with the support member 102 being disposed laterally outwardly from support member 104.

The support member 102 defines a central aperture 103a, and adjustment apertures 103b, 103c. The central aperture 103a extends in the lateral direction through the support member 102. The adjustment aperture 103b extends in the longitudinal direction, from a front side of the support member 102 to the central aperture 103a. The adjustment aperture 103c extends in the vertical direction, from a bottom side of the support member 102 to the central aperture 103a. The adjustment apertures 103b, 103c are threaded apertures. As will be described in greater detail herebelow, the central aperture 103a is configured to receive part of the primary shaft 110 therein, the adjustment aperture 103b is configured to receive part of the horizontal adjustment element 130, and the adjustment aperture 103c is configured to receive part of the vertical adjustment element 132.

The support member 104, similarly to the support member 102, defines a central aperture 105a that is also configured to receive part of the primary shaft 110 therein. Additionally, the support member 104 has an open-ended bottom section. As will be described below, the secondary shaft 120 is received through the open-ended bottom section of support member 104. A plate 106 (FIG. 6) is connected to the open-ended bottom section of the support member 104 so as to seal, and thus retain, the secondary shaft 120 within the support member 104. Although in this embodiment, the plate 106 is connected to the support member 104 by fasteners (not shown), other connection methods may be contemplated. In some instances, the bottom section of the support member 104 may not be open-ended, and may instead define an aperture for receiving the secondary shaft 120.

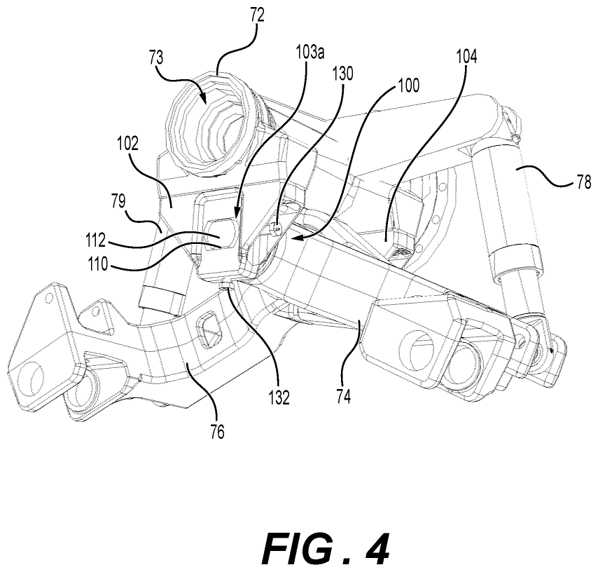

With continued reference to FIGS. 5 and 6, the primary shaft 110, which has a shaft end 112 and a shaft end 114, defines a shaft axis 111 that extends between ends 112, 114. The shaft end 112 is received in the central aperture 103a. The shaft end 112 and the central aperture 103a are configured such that the shaft end 112 is moveable within the central aperture 103a. In some embodiments, the shaft end 112 could be moveable in the vertical direction by about 0.135 inches, by about 0.27 inches, or by about 0.405 inches, and could be movable in the longitudinal direction by about 0.135 inches, by about 0.27 inches, or by about 0.405 inches. For example, in some embodiments, the movement of the shaft end 112 could be measured in terms of degrees, such that the shaft end 112 is moveable about the shaft end 114 by about five degrees in the longitudinal and/or vertical direction. In some embodiments, the shaft end 114 and/or the support member 102 could be provided with resilient portions. These resilient portions can assist in reducing vibration transmission and assist in preventing the shaft end 112 from moving freely within the central aperture 103a. The shaft end 114 is received in the central aperture 105a. As will be described in greater detail below, the shaft end 114 is connected to the secondary shaft 120, which also extends through the central aperture 105a. As will be described below, and as shown in FIG. 4 to 6, the primary shaft 110 is configured to have the upper leading and trailing members 74, 76 rotationally connect thereto.

The secondary shaft 120, which has a shaft end 122 and a shaft end 124, defines a shaft axis 121 that extends between the ends 122, 124. The secondary shaft 120, as mentioned above, is received in the support member 104 through the open-ended bottom section thereof. Thus, the secondary shaft 120 is oriented in a vertical direction (i.e., the shaft axis 121 extends generally vertically). It is to be noted that the secondary shaft 120 and the support member 104 could be configured such that the secondary shaft 120 could be oriented in a horizontal direction (i.e., the shaft axis 121 could extend generally horizontally).

The primary and secondary shafts 110, 120 are connected to one another by a ball joint 140. More precisely, the shaft end 114 is connected to the shaft 120 by the ball joint 140 within the central aperture 105a. The ball joint 140 provides a rotational connection between the primary and secondary shafts 110, 120, which enables the shaft end 112 to move in the vertical and longitudinal directions. It is contemplated that in other embodiments, the primary and secondary shafts 110, 120 could be pivotally connected to one another, instead of being rotationally connected.

The horizontal and vertical adjustment elements 130, 132 will now be described. The horizontal and vertical adjustment elements 130, 132 are threaded elements. In this particular embodiment, the horizontal and vertical adjustment elements 130, 132 are bolts but it is contemplated that other types of fasteners may be used without departing from the scope of the present technology. The horizontal adjustment element 130 is received in the adjustment aperture 103b, and the vertical adjustment element 132 is received in the adjustment aperture 103c. Due to the threaded connection between the horizontal and vertical adjustment elements 130, 132 and the adjustment apertures 103b, 103c, the position of the horizontal and vertical adjustment elements 130, 132 within the adjustment apertures 103b, 103c can be selectively adjusted. In fact, the position of the horizontal and vertical adjustment elements 130, 132 can be adjusted quickly and with readily available tools (e.g., hex key or screwdriver). The horizontal and vertical adjustment elements 130, 132 are sized so as to have their ends projecting into the central aperture 103a. Specifically, the horizontal adjustment element 130 has an end 131 that projects within the central aperture 103a, and the vertical adjustment element 132 has an end 133 that projects with the central aperture 103a. The ends 131, 133 are configured to engage with the shaft end 112. In some instances, the ends 131, 133 are fastened to the threaded apertures received in the shaft end 112. In other instances, the ends 131, 133 abut the shaft end 112. As will be described in greater detail below, the horizontal and vertical adjustment elements 130, 132 can be used to adjust the orientation of the primary shaft 110.

With continued references to FIGS. 5 and 6, the adjustment assembly 100 as it is assembled will now be described. The support member 102, 104 are connected to the central frame member 72.

The shaft end 112 is received in the central aperture 103a of the support member 102 and the shaft end 114 is received in the central aperture 105a of the support member 104. The horizontal and vertical adjustment elements 130, 132 are received in, respectively, the adjustment apertures 103b, 103c. The horizontal and vertical adjustment elements 130, 132 are then fastened until the ends 131, 133 of the horizontal and vertical adjustment elements 130, 132 extend within the central aperture 103a, and abut the shaft end 112, which limits movement of the shaft end 112 within the central aperture 103a. The secondary shaft 120 is received in the support member 104 through the open-ended bottom section, and is rotationally connected to the primary shaft 110 via the ball joint 140. The open-ended bottom section is sealed by the plate 106.

It is to be noted that prior to the connection of the primary shaft 110 to the support members 102, 104, the upper leading and trailing members 74, 76 are rotationally connected to the primary shaft 110. Specifically, the upper leading frame member 76 is rotationally connected to the primary shaft 110 by a bearing 152, and the upper trailing frame member is rotationally connected to the primary shaft 110 by a bearing 154. Thus, the primary shaft 110 supports the upper and lower leading frame members, 74, 75, the upper and lower trailing frame members 76, 77, the leading and trailing idler wheel assemblies 80, 82 and the support wheel assemblies 84a, 84b, 84c, 84d. As a result, when the orientation of the primary shaft 110 is shifted, the position of the elements mentioned hereabove is also shifted. More specifically, since, as mentioned above, the longitudinal center plane 52 of the track system 50 is in part defined by the above-mentioned elements, shifting the orientation of the primary shaft 110 results in shifting the orientation of the longitudinal center plane 52.

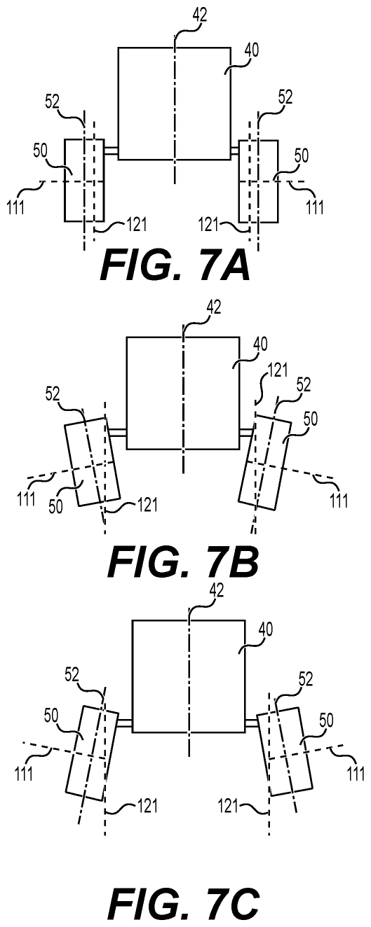

With reference to FIGS. 7A, 7B and 7C, which schematically depict one implementation of the present technology, the adjustment assembly 100 as it is adjusted between various configurations will now be described.

Referring to FIG. 7A, the adjustment assembly 100 is in a first configuration, and its shaft axis 111 is in a first orientation. In the first orientation, the shaft axis 111 is generally perpendicular to the shaft axis 121. To reach this orientation, the horizontal and vertical adjustment elements 130, 132 are adjusted in their corresponding adjustment apertures 103b, 103c, until the shaft end 114 reaches its desired position. It is contemplated that in some embodiments, the support member 102 could have markings thereon for assisting in positioning the shaft end 112 within the central aperture 103a. As a result of the orientation of the primary shaft 110, the longitudinal center plane 52 of the track system 50 is generally parallel to a longitudinal center plane 42 of the vehicle 40.

Referring to FIG. 7B, the adjustment assembly 100 is in a second configuration, and the shaft axis 111 is in a second orientation. In the second orientation, the shaft axis 111 is skewed relative to the shaft axis 121, such that a laterally inward point of the shaft axis 111 is vertically higher than a laterally outward point of the shaft axis 111 (i.e., shaft end 112 is vertically lower than shaft end 114). To reach this orientation, the vertical adjustment element 132 is adjusted in the adjustment aperture 103c. As a result of the orientation of the primary shaft 110, the longitudinal center plane 52 of the track system 50 is no longer parallel to the longitudinal center plane 42 of the vehicle 40. Instead, the longitudinal center plane 52 is oriented such that a projection of the longitudinal center plane 52 intersects with a projection of the longitudinal center plane 42 of the vehicle 40, the intersection occurring at a point vertically lower than the primary shaft 110. In this configuration, a camber angle of the track system 50 has changed, such that a laterally outer section of the endless track 90 engages the soil. It is contemplated that in other embodiments where the track system 50 is connected to the vehicle 40 with an initial camber angle, adjusting the adjustment assembly 100 to the second configuration may cause a middle section of the endless track 90 to engage the ground.

Referring to FIG. 7C, the adjustment assembly 100 is in a third configuration, and the shaft axis 111 is in a third orientation. In the third orientation, the shaft axis 111 is skewed relative to the shaft axis 121, such that a laterally inward point of the shaft axis 111 is vertically below a laterally outward point of the shaft axis 111 (i.e., shaft end 112 is higher than shaft end 114). To reach this orientation, the vertical adjustment element 132 is adjusted in the adjustment aperture 103c, until the shaft end 112 reaches its desired position. As a result of the orientation of the primary shaft 110, the longitudinal center plane 52 of the track system 50 is no longer parallel to the longitudinal center plane 42 of the vehicle 40. Instead, the longitudinal center plane 52 is oriented such that a projection of the longitudinal center plane 52 of the track system 50 intersects with a projection of the longitudinal center plane 42 of the vehicle 40, the intersection occurring at a point vertically higher than the primary shaft 110. In this configuration, a camber angle of the track system 50 has changed, such that a laterally inner section of the endless track 90 engages the soil. It is contemplated that in other embodiments where the track system 50 is connected to the vehicle 40 with an initial camber angle, adjusting the adjustment assembly 100 to the third configuration may cause a middle section of the endless track 90 to engage the ground.

Although not described in detail herewith, it is understood that the longitudinal orientation of the track system 50 (toe of the track system) can be adjusted by the horizontal adjustment element 130 similarly.

The adjustment assembly 100 can assist in correcting the alignment between the endless track 90 and the rest of the track system 50 (frame assembly 70 and wheel assemblies 60, 80, 82, 84a, 84b, 84c, 84d). Indeed, by changing the camber angle (by changing configuration of the adjustment assembly 100 as described hereabove), forces applied on the inner surface 92 by the idler and support wheel assemblies 80, 82, 84a, 84b, 84c, 84d are changed (i.e., applied forces move along a widthwise direction of the endless track 90). This movement of the pressure along the widthwise direction of the endless track 90 changes the alignment of the endless track 90 relative to the rest of the track system 50. This can be useful to extend life of the endless track 90 by limiting premature wear. It has been determined, through testing, that adjusting the camber angle can be an effective way to correct the alignment of the endless track 90. That said, in the present embodiment, alignment of the endless track 90 with the rest of the track system 50 can be corrected by modifying the camber angle by adjusting the vertical adjustment element 132 and/or by modifying the toe angle by adjusting the horizontal adjustment element 130.

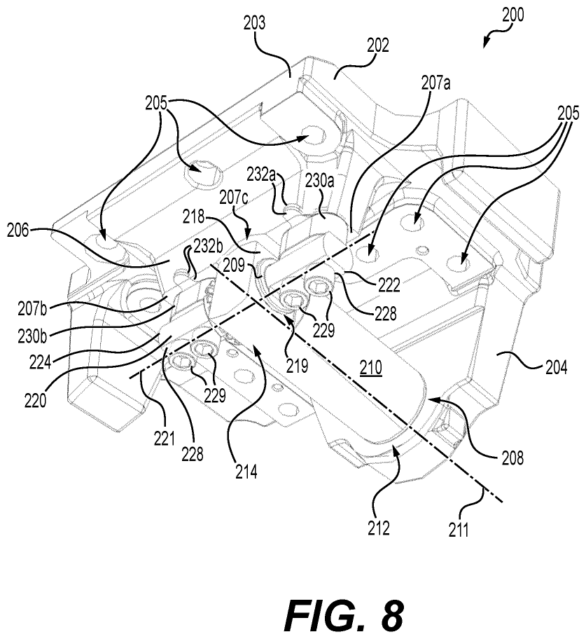

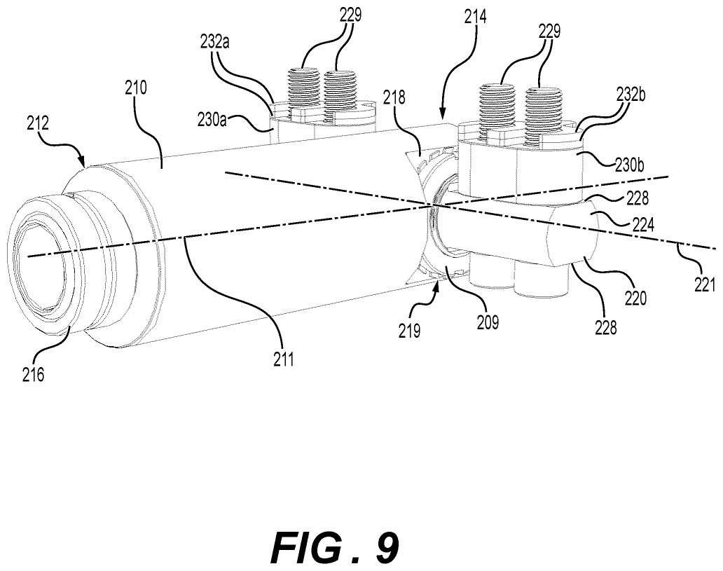

With reference to FIGS. 8, 9 and 10A to 10F, an alternative embodiment of the adjustment assembly 100, namely adjustment assembly 200 will now be described in greater detail. In the non-limiting illustrated embodiment of FIGS. 8 and 9, the adjustment assembly 200 includes a primary shaft 210, a secondary shaft 220, a left spacing element 230a, a right spacing element 230b, two left adjustment elements 232a and two right adjustment elements 232b. As will be described in greater detail below, in some embodiments, there could only be one of each of the left and right adjustment elements 232a, 232b. In other embodiments, there could be three or more of each of the left and right adjustment elements 232a, 232b.

The adjustment assembly 200 is connected to a support member 202, which in turn is connected to the central frame member 72. In some implementations of the present technology, the support member 202 could be considered to be part of the adjustment assembly 200. In other embodiments, the support member 202 could be integral with the central frame member 72. Additionally, it is contemplated that in some embodiments, the adjustment assembly 200 could be connected elsewhere. For instance, in some embodiments, the adjustment assembly 200 could be configured to interconnect the upper and lower leading frame members 74, 75.

The support member 202 has a base 203, a connecting portion 204 and a connecting portion 206. The connecting portions 204, 206, which are laterally spaced from one another, extend downwardly from the base 203. The connecting portion 204 extends downwardly further than the connecting portion 206.

The base 203 defines a plurality of apertures 205 that are configured to receive fasteners (not shown) by which the base 203 can be connected to the central frame member 72. It is contemplated that the base 203 could be connected to the central frame member 72 differently.

The connecting portion 204 has a connector 208 that is configured to connect with the primary shaft 210. In the present embodiment, the connector 208 includes a pillow block bearing, but other connectors are contemplated. As will be described in greater detail below, the connector 208 is configured to rotationally connect with the primary shaft 210.

The connecting portion 206 has left and right flat segments 207a, 207b, which are spaced from one another by an arcuate recess 207c. In some embodiments, the left and right flat segments 207a, 207b may not be flat. Each of the left and right flat segments 207a, 207b defines fastening apertures (not shown) configured to receive part of fasteners 229 therein. In this embodiment, each of the left and right flat segments 207a, 207b defines two fastening apertures, but it is understood that more or fewer fastening apertures could be defined therein.

The primary shaft 210, which has an end 212 and an end 214, defines a shaft axis 211 that extends between ends 212, 214. The primary shaft 210 has, at the end 212, a connector 216 (FIG. 9) that is configured to connect to the connector 208 of the connecting portion 204 such that there is a rotational connection between the primary shaft 210 and the connecting portion 204. More specifically, in the illustrated embodiment, the connector 216 is an elongated protrusion, and the connector 208 includes the pillow block bearing in which the connector 216 is receivable. It is contemplated that the rotational connection between the end 212 and the connecting portion 204 could be achieved differently. For example, in some embodiments, the connector 216 could be a semi-circular recess, and the connector 208 could be a circular protrusion that is configured to be received in the semi-circular recess, thereby providing a rotational connection by a ball and socket connection.

At the end 214, the primary shaft 210 has two flat recessed portions 218 that are opposite to one another. Furthermore, at the end 214, the primary shaft 210 defines an aperture 219 that extends between the flat recessed portions 218. In some embodiments where the flat recessed portions 218 are omitted, the aperture 219 extends across an entirety of the width of the primary shaft 210. As will be described in greater detail below, the aperture 219 is sized to receive the secondary shaft 220 as well as a bearing 209 therein.

Although not illustrated herein, the primary shaft 210 is configured to, akin to the primary shaft 110, have the upper leading and trailing members 74, 76 rotationally connect thereto. Thus, the primary shaft 210 supports the upper and lower leading frame members, 74, 75, the upper and lower trailing frame members 76, 77, the leading and trailing idler wheel assemblies 80, 82 and the support wheel assemblies 84a, 84b, 84c, 84d. As a result, when the orientation of the primary shaft 210 is shifted, the position of the elements mentioned hereabove are also shifted. More specifically, since the longitudinal center plane 52 of the track system 50 is in part defined by the above-mentioned elements, shifting the orientation of the primary shaft 210 results in shifting the orientation of the longitudinal center plane 52. Furthermore, in the illustrated embodiment, the axis 211 can be referred to as a pitch axis.

With continued reference to FIGS. 8 and 9, the secondary shaft 220 will now be described in greater detail. The secondary shaft 220, which has an end 222 and an end 224, defines a shaft axis 221 that extends between ends 222, 224.

At the end 222, the secondary shaft 220 has upper and lower recessed sections 226, and at the end 224, the secondary shaft 220 has upper and lower recessed section 228. The upper and lower recessed sections 226, 228 are generally flat, which, as will be described in greater detail below, can assist in reducing stresses in the adjustment assembly 200. The secondary shaft 220 defines two generally vertical fastening apertures at the end 222, and two generally vertical fastening apertures at the end 224. The fastening apertures (not shown) that are configured to receive the fasteners 229 therein. It is contemplated that the number of fastening apertures (and thus number of fasteners 229) could vary from one embodiment to another.

The secondary shaft 220 is configured to be received in the aperture 219 of the primary shaft 210 in such a manner that the primary shaft 210 is rotatable relative to the secondary shaft 220 about the shaft axis 221. In the non-limiting illustrated embodiment, the bearing 209 is disposed between the primary and secondary shafts 210, 220. In other embodiments, the bearing 209 could be omitted, and lubricant may be used to obtain a rotational connection between the primary and secondary shafts 210, 220.

In the illustrated embodiment, the secondary shaft 220 is configured to connect to the connecting portion 206 such that the shaft axis 221 is oriented to be generally horizontal. It is contemplated, however, that in some embodiments, the secondary shaft 220 could be oriented to be generally vertical.

The left and right spacing elements 230a, 230b are similar, and thus only the left spacing element 230a, will be described herewith. The left spacing element 230a, which has flat upper and lower surfaces, defines two generally vertical fastening apertures (not shown) that extend therethrough. It is contemplated that in some embodiments, the left spacing element 230a could be configured to define a different number of fastening apertures. The fastening apertures are configured to receive the fasteners 229. The left spacing element 230a is sized so that when the adjustment assembly 200, fully assembled, is connected to the support member 202, the primary shaft 210 does not abut with the connecting portion 206. Thus, the spacing element 230a is configured to provide clearance for movement of the primary shaft 210. In some embodiments, the left spacing element 230a has a thickness of about 0.925 inches. In other embodiments, the left spacing element 230a could have a thickness of about 1 inch, of about 1.25 inches or of about 0.900 inches.

The left and right adjustment elements 232a, 232b will now be described. As mentioned above, the number of left and right adjustment elements 232a, 232b present in the adjustment assembly 200 could change from one configuration of the adjustment assembly 200 to another. As the left and right adjustment elements 232a, 232b are similar, only the left adjustment element 232a will be described herewith. The adjustment element 232a, which has flat upper and lower surfaces, defines two generally vertical apertures (not shown) configured to receive the fasteners 229. It is contemplated that in some embodiments, the adjustment element 232a could define a different number of apertures. The adjustment element 232a has a thickness of about 0.135 inches. In some embodiments, the adjustment element 232a could have a thickness of about 0.144 inches, about 0.160 inches, about 0.176 inches, of about 180 inches, of about 0.128 inches, of about 0.116 inches, or of about 0.110 inches. The adjustment element 232a has a tab 234, which enables a user to easily grasp the adjustment element 232a.

As will be described below, the left and right adjustment elements 232a, 232b enable to adjust the orientation of the primary shaft 210, and thus of the shaft axis 211, relative to the frame member 202. It is understood that the configuration of the adjustment elements 232a, 232b could vary from one embodiment to another. For example, in some embodiments, the left and right adjustment elements 232a, 232b could be connected to one another so as to form a single adjustment element.

In the illustrated embodiments, the fasteners 229 are bolts. It is contemplated, however, that the fasteners 229 could be another threaded element, or another fastener that provides a selective connection.

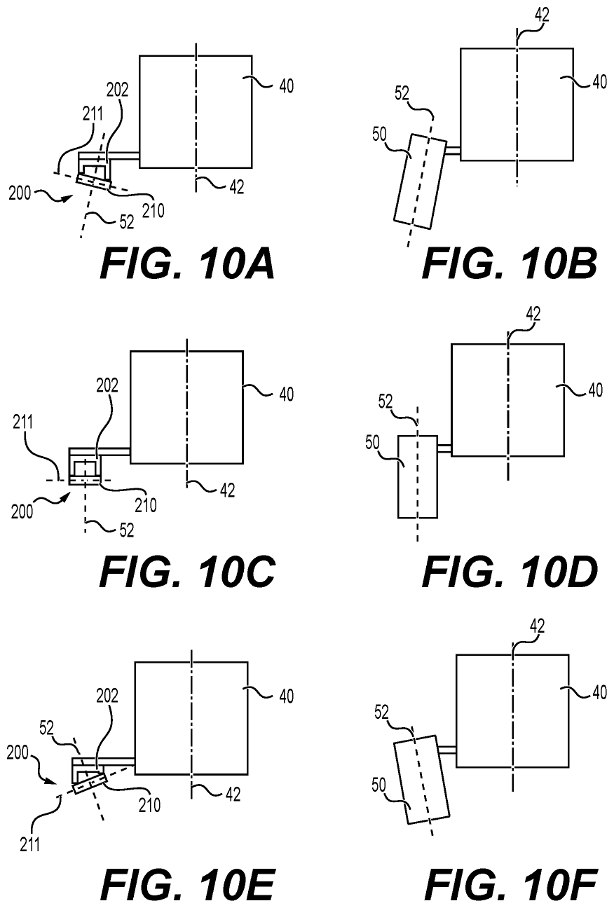

With reference to FIGS. 10A and 10B, the adjustment assembly 200 will now be described as it is fully assembled in a first configuration. In the first configuration, the left and right adjustment elements 232a, 232b are omitted from the assembled adjustment assembly 200.

The secondary shaft 220 is received in the bearing 209, which in turn is disposed in the aperture 219 of the primary shaft 210. When the primary and secondary shafts 210, 220 are connected to one another, the axis 211 is perpendicular to the axis 221, and the primary shaft 210 is rotatable about the axis 221. As mentioned above, the top of the primary shaft 210 does not abut with the connecting portion 206 due to the height of the left and right spacing elements 230a, 230b. In some instances, the top of the primary shaft 210 could be received in the arcuate recess 207c. At the end 212, the connector 216 of the primary shaft 210 is connected to the connector 208. At the end 214, the fasteners 229 are selectively received in the fastening apertures of the secondary shaft 220, of the left and right spacing elements 230a, 230b and of the connecting portion 206. As a result, the primary and secondary shafts 210, 220 are selectively secured to the support member 202.

In the implementation illustrated in FIGS. 10A and 10B, when the adjustment assembly 200 is in the first configuration, the primary shaft 210 is oriented in a first position in which the shaft axis 211 is skewed relative to the support member 202. More specifically, the primary shaft 210 is oriented such that a laterally inward point of the shaft axis 211 is vertically lower than a laterally outward point of the shaft axis 211. This orientation is, in part, enabled by the rotational connection between the primary shaft 210 and the support member 202.

Thus, in the first configuration, the longitudinal center plane 52 of the track system 50 is not parallel to the longitudinal center plane 42 of the vehicle 40, such that a projection of the longitudinal center plane 52 of the track system 50 intersects with a projection of the longitudinal center plane 42 of the vehicle 40, the intersection occurring vertically higher than the primary shaft 210. In this configuration, as shown in FIG. 10B, a laterally inner section of the endless track 90 engages the soil. It is to be noted that this may be different in other embodiments of the track system. It is contemplated that in other embodiments where the track system 50 is connected to the vehicle 40 with an initial camber angle, adjusting the adjustment assembly 200 to the first configuration may cause a middle section of the endless track 90 to engage the ground.

With reference to FIGS. 10C and 10D, the adjustment assembly 200, when it is in a second configuration, will now be described. The second configuration differs from the first configuration in that the adjustment assembly 200, when assembled, further includes one of each of the left and right adjustment elements 232a, 232b, in addition to the primary and secondary shafts 210, 220 and the spacing elements 230a, 230b.

Thus, in this configuration, the fasteners 229 are selectively received in the fastening apertures of the left and right adjustment elements 232a, 232b in addition to being received in the fastening apertures of the secondary shaft 220, of the left and right spacing elements 230a, 230b.

In the second configuration, due to the thickness of the left and right adjustment elements 232a, 232b, the primary shaft 210 is oriented in a second position in which the shaft axis 211 is generally perpendicular relative to the support member 202. The movement of the primary shaft 210 from the first position to the second position is enabled by the rotational connection between the primary shaft 210 and the support member 202.

In the second configuration, the longitudinal center plane 52 of the track system 50 is generally parallel to the longitudinal center plane 42 of the vehicle 40. In this configuration, as shown in FIG. 10D, a camber angle between the frame assembly 50 and the endless track 90 is changed, such that a middle section of the endless track 90 engages the soil. Sometimes, the second configuration is referred to a neutral configuration due to the position of the primary shaft 210. It is contemplated that in other embodiments where the track system 50 is connected to the vehicle 40 with an initial camber angle, adjusting the adjustment assembly 200 to the second configuration may cause another section of the endless track 90 to engage the ground.

With reference to FIGS. 10E and 10F, the adjustment assembly 200, when it is in a third configuration, will now be described. The third configuration differs from the first configuration in that, the adjustment assembly 200 includes two of each of the left and right adjustment elements 232a, 232b, in addition to the primary and secondary shafts 210, 220 and the spacing elements 230a, 230b.

Thus, in this configuration, the fasteners 229 are selectively received in the fastening apertures of two of the left and right adjustment elements 232a, 232b in addition to being received in the fastening apertures of the secondary shaft 220, of the left and right spacing elements 230a, 230b.

In the third configuration, due to the thicknesses of the left and right adjustment elements 232a, 232b, the primary shaft 210 is in a third position in which the axis 211 is skewed relative to the support member 202. More specifically, the primary shaft 210 is oriented such that a laterally inward point of the axis 211 is vertically higher than a laterally outward point of the axis 211. The movement of the primary shaft 210 between the first position or the second position to the third position is enabled by the rotational connection between the primary shaft 210 and the support member 202.

Thus, in the third configuration, the longitudinal center plane 52 of the track system 50 is not parallel to the longitudinal center plane 42 of the vehicle 40, such that a projection of the longitudinal center plane 52 of the track system 50 intersects with a projection of the longitudinal center plane 42 of the vehicle 40, the intersection occurring vertically lower than the primary shaft 210. In this configuration, as shown in FIG. 10F, a camber angle between the frame assembly 50 and the endless track 90 is changed, such that a laterally outer section of the endless track 90 engages the soil. In some configuration the track system 50 being in the third configuration can be optimal for track systems travelling on a crowned road.

Thus, the adjustment assembly 200 can assist in correcting the alignment between the endless track 90 and the rest of the track system 50 (frame assembly 70 and wheel assemblies 60, 80, 82, 84a, 84b,84c, 84d). Indeed, by changing the camber angle (by changing configuration of the adjustment assembly 200 as described hereabove), forces applied on the inner surface 92 by the idler and support wheel assemblies 80, 82, 84a, 84b, 84c, 84d are changed, move along a widthwise direction of the endless track 90. This movement of the pressure along the widthwise direction of the endless track 90 changes the alignment of the endless track 90 relative to the rest of the track system 50. This can be useful to extend life of the endless track 90 by limiting premature wear. It has been determined, through testing, that adjusting the camber angle can be an effective way to correct the alignment of the endless track 90.

It is to be noted that that the orientation of the primary shaft 210 can be adjusted between the first, second and third positions without creating high stress points. Indeed, the adjustment assembly 200 is configured so that the forces that are applied on the adjustment elements 232a, 232b, on the spacing elements 230a, 230b and the secondary shaft 220 are distributed over an entirety of their flat surfaces, thereby reducing the stress that the various elements are being subjected to. It is contemplated that in some embodiments, one or more of the adjustment elements 232a, 232b, on the spacing elements 230a, 230b and the secondary shaft 220 could not be flat.

Furthermore, because the fasteners 229 are easily accessible and easy to remove and install (using tools such as a screwdriver or a hex key), it makes adjusting the adjustment assembly 200 between the first, second and third configurations a quick and easy process.

Additionally, due to the configuration of the adjustment assembly 200, changing the number of adjustment elements 232a, 232b causes the orientation of the primary shaft 210 to move by a known amount, such that there is little uncertainty when adjusting the configuration of the adjustment assembly 200.

In the present embodiment, the adjustment elements 232a, 232b are shown only connected toward the end 214 of the primary shaft 210. It is contemplated that in other embodiments, the adjustment assembly 200 could be configured so that the adjustment elements 232a, 232b could be connected toward the end 212 or connected toward both ends 212, 214. In some instances, the adjustment assembly 200 is configured to have the adjustment elements 232a, 232b on a side that is easily accessible (i.e. outwardly).

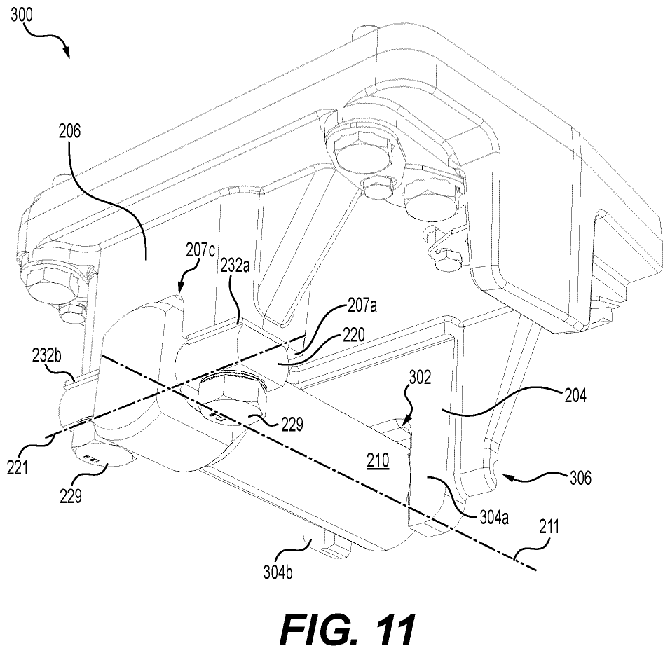

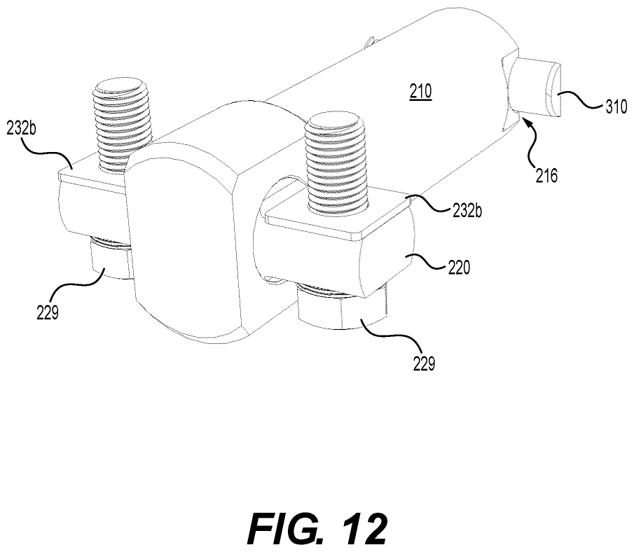

With reference to FIGS. 11 and 12, an alternative embodiment of the adjustment assembly 200, namely adjustment assembly 300, will now be described. Features of the adjustment assembly 300 similar to those of the adjustment assembly 200 have been labeled with the same reference numerals, and will not be described in detail herewith again.

In the illustrated embodiment, the adjustment assembly 300 includes the primary shaft 210, the secondary shaft 220, one left adjustment element 232a, one right adjustment element 232b and two fasteners 229. It is understood that the adjustment assembly 300 could be adjustable to a number of different configurations having a different number of adjustment elements. Thus, the adjustment assembly 300 differs from the adjustment assembly 200 in that the spacing elements 230a, 230b are omitted. As a result of this omission, the arcuate recess 207c defined in the connecting portion 206 extends further therein.

Another notable difference between the adjustment assembly 300 and the adjustment assembly 200 is the connection between the primary shaft 210 and the support member 202. More specifically, the primary shaft 210 is connected to the support member 202 by a pivotal connection instead of a rotational connection, which can result in the adjustment assembly 300 being cheaper to manufacture and transmitting less vibrations.

The connecting portion 204 defines a recess 302 between two side sections 304a, 304b. Each one of the side sections 304a, 304b defines an aperture 306 (only one of the apertures shown in the illustrated embodiment).

In this embodiment, the connector 216 is an aperture 216. The aperture 216 is generally parallel to the aperture 219 (i.e., an axis extending along the aperture 216 is parallel to an axis extending along the aperture 219).

The adjustment assembly 300 further includes a connecting shaft 310 that is received in the apertures 306 of the side sections 304a, 304b and in the aperture 216. The connecting shaft 310 is rotatable relative to the connecting portion 206 and the primary shaft 210, such that the primary shaft 210 is pivotable relative to the support member 202 about the connecting shaft 310.

The adjustment assembly 300 works similarly to the adjustment assembly 200, and thus its operation and various configurations will not be re-described herewith.

In any one of the above embodiments, the adjustment elements 130, 132, 232a, 232b are shown as being on an outer lateral side of the shafts 100, 200, because the outer lateral side is more easily accessible in certain embodiments. It is understood however, that in other embodiments, the adjustment elements 130, 132, 232a, 232b could be on the inner lateral side or on both lateral sides.

Modifications and improvements to the above-described embodiments of the present invention may become apparent to those skilled in the art. The foregoing description is intended to be exemplary rather than limiting. The scope of the present invention is therefore intended to be limited solely by the appended claims.

1. An adjustment assembly for a track system, the adjustment assembly comprising:
a first shaft having a first shaft end and a second shaft end, and defining a first shaft axis extending along the first and the second shaft ends, the first shaft end being connectable to a support member of the track system;
a second shaft having a third shaft end and a fourth shaft end, and defining a second shaft axis extending along the third and the fourth shaft ends, the second shaft being connected to the first shaft such that the first shaft is at least pivotable about the second shaft axis, and the second shaft being connectable to the support member such that in response to the first shaft being in a first position relative to the second shaft, the first and second shaft axes are generally perpendicular to one another; and
an adjustment element engaged with one of the first and second shafts, the adjustment element being suitable for adjusting an orientation of the first shaft axis relative to the support member.

2. The adjustment assembly of claim 1, wherein the adjustment element is engaged with the first shaft.

3. The adjustment assembly of claim 2, wherein the adjustment element is engaged with the first shaft end.

4. The adjustment assembly of claim 2, wherein the first shaft is connectable to the support member by being at least partially receivable through an aperture defined in the support member, and the adjustment element being at least partially receivable in the aperture.

5. (canceled)

6. The adjustment assembly of claim 1, wherein movement of the adjustment element is configured to modify orientation of the first shaft axis in a first direction relative to the support member.

7. The adjustment assembly of claim 1, further comprising a second adjustment element engaged with the one of the first and second shafts.

8. The adjustment assembly of claim 7, wherein movement of the second adjustment element is configured to modify orientation of the first shaft axis in a second direction relative to the support member.

9. The adjustment assembly of claim 8, wherein the first and second directions are opposite to one another.

10. The adjustment assembly of claim 8, wherein the first direction is generally perpendicular to the second direction.

11. The adjustment assembly of claim 1, wherein the adjustment element is disposable between the support member and the one of the first and second shafts.

12. The adjustment assembly of claim 11, wherein:
each of the third and fourth shaft ends of the second shaft has a flat edge for engagement with the adjustment element; and
the adjustment element has a contact surface for engagement with the flat edges of the second shaft.

13. The adjustment assembly of claim 11, wherein the first shaft is configured to rotationally connect to the support member.

14. The adjustment assembly of claim 13, wherein the first shaft is configured to connect to the support member by a spherical joint.

15. The adjustment assembly of claim 11, wherein the first shaft is configured to pivotally connect to the support member.

16. The adjustment assembly of claim 11, wherein:
the adjustment element is a first adjustment element;
the adjustment assembly further includes a second adjustment element, and
the first adjustment element is engaged with the third shaft end, and the second adjustment element is engaged with the fourth shaft end.

17. The adjustment assembly of claim 11, wherein:
the adjustment element is a first adjustment element;
the adjustment assembly further includes a second adjustment element, and
the first adjustment element is configured to engage with the one of the first and second shafts and with the second adjustment element, and the second adjustment element is configured to engage with the first adjustment element and the support member
the first and second adjustment elements being configured to cause adjustment of an orientation of the first shaft axis relative to the support member.

18. (canceled)

19. The adjustment assembly of claim 1, wherein the second shaft extends through the first shaft.

20. The adjustment assembly of claim 1, further comprising at least one fastener configured to selectively connect the third shaft end to the support member.

21. The adjustment assembly of claim 1, further comprising the support member.

22.-23. (canceled)

24. A track system connectable to a vehicle, the track system comprising:
a frame assembly including a first frame portion, a second frame portion, and a support member;
the adjustment assembly of claim 1 connected to the support member, the adjustment assembly interconnecting the first and second frame portions;
a plurality of wheel assemblies connected to the frame assembly; and
an endless track surrounding the frame assembly, the adjustment assembly and the plurality of wheel assemblies.

25.-29. (canceled)
